(19) United States
(12) Patent Application Publication
(10) Pub. No.: US 2015/0007060 A1
(43) Pub. Date: Jan. 1, 2015

(54) System and Method for an Improved Communication and Interactive News Forum

(71) Applicant: Christine Marie NIELSEN, (US)

(72) Inventor: Christine Marie Nielsen, Greenfield, WI (US)

(21) Appl. No.: 14/371,097

(22) PCT Filed: Jan. 9, 2013
(86) PCT No.: PCT/US13/20911

§ 371 Date: Jul. 8, 2014

Related U.S. Application Data
(60) Provisional application No. 61/584,731, filed on Jan. 9, 2012.

(51) Int. Cl. H04L 29/06; G06F 3/0484

(52) U.S. Cl. CPC H04L 65/4038; G06F 3/0484
USPC 715/753

(57) ABSTRACT

Embodiments of the present invention are directed to a system and methods for an improved communication and interactive news forum. Certain embodiments of the present invention are configured to facilitate structured discussions via a computer network by which user context information and project management resources are accessible.

This application claims the benefit of U.S. Provisional Application No. 61/584,731 filed Jan. 9, 2012.

### FIELD OF THE INVENTION

The present invention relates to an improved communication and interactive news forum configured to facilitate controlled exchange of information and incorporate the context of each user and his or her circumstances. Embodiments of the present invention facilitate dialog on a single dedicated platform, identifying shared issues reported by traditional news outlets and making possible the finding and implementation of solutions to those issues.

### BACKGROUND OF THE INVENTION

From time to time, two or more people located remotely from one another wish to communicate with one another about a topic. The goal of the communication may be to exchange educational information or to develop a plan to solve a problem. A wide variety of conventional approaches for facilitating such communication exist.

For example, a simple way to communicate with a second remotely located person is to prepare a written correspondence and send it to the other person through the postal mail. However, while such communication method is generally inexpensive, it takes a number of days for the correspondence to reach the recipient. In addition, to reach a broader audience, a correspondence may be sent to each location at which an intended recipient is located.

To more efficiently communicate with a broader audience, certain media conventions have been developed to permit communication, for example, through distribution of newspapers, radio broadcasts, and television broadcasts. However, there are certain disadvantages associated with such media conventions. Specifically, such conventions constitute generally one-way communication. Also, conventional newspapers are often static in nature since they are updated only once a day. While these conventions permit a user to observe news stories about the outside world, the user's personal circumstances are typically not a part of the story or other information. Also, media conventions typically do not provide solutions or actions to be taken in response to the story or information.

Also, traditional media conventions typically prepare and broadcast information about specific regions. Moreover, traditional media model often involves reporting problems, issues, and topics in a fragmented way. Often, the dots are not connected regarding problems from region to region and no solution is sought.

To overcome the limitations of slow, static, and one-way communication, electronic transfer of information over computer networks has been developed. For example, a computer user can send and receive electronic messages through email systems much faster than the exchange of correspondence through postal carriers. However, email systems are still associated with certain disadvantages. Email messages must be distributed to targeted users, not a general audience. In addition, email messages often display limited information about the user such as the user's name and email address, but not much additional information. Email messages also permit transfer of images, text, and video files, but due to the large size of such files, the number of files that can be transferred at one time is often limited.

Another electronic information transfer convention permits transfer or streaming of large files such as video files. For example, video distribution systems permit uploading and distributing large video files through an online video distributor (e.g., YouTube and Current TV) permit users to upload and distribute videos to many users at one time. However, the video files uploaded to such systems are often discrete files not part of a larger context of information and do not permit direct communication between users.

To communicate directly with another user, a user may use a video calling system to simultaneously receive video and audio content, such as Skype, Google Voice, Google Chat, or FaceTime. Certain video calling systems permit the user to receive a video call, but not to transfer other types of items or view information about the other user simultaneously. Also, if more than two users are on a video call, the users may have a challenge managing the conversation such that each user can be identified and heard.

Another electronic information transfer convention includes social media networks. While certain social networks permit users to connect with other users by sending and receiving text, posting text and images, posting news articles, and posting and viewing personal information about other users, conventional social networks offer limited resources for structured discussions. A user may wish to conduct a structured discussion or other type of communication to solve a problem, examine an issue, or otherwise exchange information. In addition, when problem solving is the objective, social networks provide limited project management resources.

Clearly, many disadvantages are associated with known communication conventions.

There is a demand for a system and methods configured to facilitate the structured discussions over a computer network by which user information is easily accessible and project management resources are available. Embodiments of the present invention satisfy this demand.

### SUMMARY OF THE INVENTION

Certain embodiments of the present invention include a dedicated platform for providing information about shared problems and facilitating change. More specifically, certain embodiments of the present invention facilitate dialog in a single platform in an issues-based manner and facilitates finding and implementing solutions.

More specifically, certain embodiments of the present invention are configured to facilitate communication between users of a system and methods. In certain embodiments, users from all over the world (or in any two or more locations) may have a virtual discussion through the system or using the methods. Users in the same general location (e.g., in the same room or in the same building) may use the system and methods to communicate as well. Advantageously, the present invention may be used to facilitate discussions on any variety of topics.

In addition to facilitating communication, certain embodiments of the present invention are configured to operate in the context of relatively new technology (social media) and increasing travel trends. Users may include global citizens who are ready to move beyond being bystanders of conventional media and wish to communicate and take action. They are ready to acknowledge the big picture and be empowered with information to become part of the solution.

Embodiments of the present invention may permit users to form online communities or in-person communities that endeavor to tackle a certain issue. These communities may include religious communities, Wise Elders, students, medical communities, non-profits, etc.

Certain embodiments of the present invention may include a profile page user interface configured to show how a topic plays out in the user's region and life. The user becomes a part of the story through their profile page, geomapping, crisis mapping and the inclusion of statistics and data about their region, and with their own narrative and input help to build a rich database of information about the topic. Embodiments of the present invention include interactive news site, in which users of the site and their individual circumstances are part of the story and eventually part of the solution. When a user speaks in a forum, the user's profile including user information and regional information are highlighted.

The various users may have some association or connection from outside of the system and methods. For example, a company, organization, or other entity may use the system and methods to conduct meetings for employees or members.

In other embodiments, the users are not associated with one another before using the system and methods. Such embodiments of the system and methods are configured to identify one or more users who wish to communicate with other users about a certain topic.

For purposes of this application, the term “topic” includes any issue that a user wishes to discuss. The term “topic” will be used interchangeably with the term “issue” in this application. Specifically, a “topic” may include current events including current global events, current regional events, and current local events; historical events; sporting events; political issues such as elections, legislation, civil rights, employment, taxes, regulations, trading among countries/regions, debt, guns, constitutional rights, educational issues, government programs, government-issued benefits, immigration, tort reform, military and defense, treaties, nuclear weapons, non-nuclear weapons, pollution, climate change; science issues such as genetically engineered organisms, stem cell research, natural disasters, health issues including diseases, pregnancy, obesity, biodiversity, food safety, mental health, suicide, and health policies, energy issues such as renewable energy, recycling, energy consumption, and energy generation; high speed rail, war, United Nations, unions, political parties, race issues including affirmative action and discrimination; business issues such as accounting, regulatory, business strategy, business growth, research and development, production, manufacturing, importing and exporting goods and services; economic issues including economic inequality and economic instability; financial issues; legal issues; entertainment; art issues; cultural issues; religious issues; collectible items, fashion, music, clothing, footwear, and other wearable items; weddings, funerals, awards shows, and entities such as people, companies, non-profits, educational entities, and government entities including local government, state/provincial government, top-level government, government bureaus, government agencies, and other people, places, events, policies, attitudes, problems, goals, or things.

For purposes of this application, the term “region” means a planet, hemisphere, continent, group of countries (e.g., European Union, NATO countries), country, a specific area not delineated by country borders (e.g., Central Time Zone, Midwest part of United States, Mississippi River Basin, Island), state, province, territory, county, city, town, village, island, peninsula, commune, ocean, sea, lake, population of people not delineated by country, or other area.

Certain embodiments of the present invention are configured to gather and convey information about a topic from various sources. For example, some information may include an article published in peer-review journals, newspapers, magazines, blogs, music, art, Twitter entries, Facebook entries, LinkedIn entries, and other social media entries. The information published in the system and using the methods of the present invention may come from professional journalists, citizen journalists, publications, observers, researchers, editors, and Institutions. In certain embodiments, articles and information is solicited from specific people with expertise on a topic or people located in specific regions.

An embodiment of the present invention may include system having a virtual event component and a user information component. The system also may include one or more of a topic information component, region information component, financial component, a project management component, and translation component. In addition, embodiments of the system may include a user interface configured to be viewable in a display and, more generally, a computer system.

Certain embodiments of the present invention include an advertising component configured to permit advertisers to purchase and exhibit an advertisement for a good or service. Such component may permit the advertisers to target users who have certain qualities, are active in certain topic groups, have certain information in their profile information, live or visit certain regions, or have a geolocation. In certain embodiments, geolocation may permit advertisers to target their goods and services to users and customers in applicable areas and tailor their advertisements to each individual. Certain embodiments are a modernized version of the advertising and revenue model from local newspapers.

An embodiment of the present invention may include a method of creating a global town hall system by which users may employ interactive video and other social media with the goal of discussing issues reported by traditional and nontraditional media outlets and identifying possible solutions.

An object of certain embodiments of the present invention is to provide a system and methods through which users may find other users that wish to discuss a topic.

An object of certain embodiments of the present invention is to provide a system and methods through which users may find other users that wish to take actions related to a topic.

Another object of certain embodiments of the present invention is to advance intercultural dialog through implementation of the platform on inexpensive computers and/or mobile devices.

Another object of certain embodiments of the present invention is to provide a system and methods through which users may find other users that wish to address a topic wherein the users have not had any connection with other users outside of the system and methods before engaging in the system and methods.

Another object of certain embodiments of the present invention is to provide a system and methods through which users may find other users that wish to address a topic wherein the users have had some connection outside of the system and methods before engaging in the system and methods.

Another object of certain embodiments of the present invention is to provide a system and methods through which a user can quickly and easily ascertain context information about another user.

Another object of certain embodiments of the present invention is to provide a system and methods through which a user can exchange information with other users without having to target the information to a particular user.

Another object of certain embodiments of the present invention is to provide a system and methods through which a user can exchange information with other user by sending that information directly to the specific user.

Another object of certain embodiments of the present invention is to provide a system and methods through which users may conduct structured virtual meetings using a predetermined procedure.

Another object of certain embodiments of the present invention is to provide a system and methods through which users may conduct structured virtual meetings using parliamentary procedure according to Robert's Rules of Order, which is incorporated by reference in its entirety.

Another object of certain embodiments of the present invention is to provide a system and methods through which users may avoid the chaos of many people typing or talking at once.

Another object of certain embodiments of the present invention is to provide a system and methods through which users may conduct structured virtual meetings in which context information of the speaker is displayed while the speaker's voice and or video is being transmitted to other users.

Another object of certain embodiments of the present invention is to provide a system and methods by which users may conduct structured virtual meetings and simultaneously exchange information files related to the topic.

Yet another object of certain embodiments of the present invention is to provide a system and methods through which users may obtain information from a wide variety of sources.

Yet another object of certain embodiments of the present invention is to provide a system and methods through which users may conduct structured virtual meetings in which certain users are committee participants and certain users are merely listeners or observers.

Yet another object of certain embodiments of the present invention is to provide a system and methods configured to generate project goals for taking some action related to a topic.

Yet another object of certain embodiments of the present invention is to provide a system and methods configured to facilitate formation of committees or action communities accomplishing project goals related to a topic.

Yet another object of certain embodiments of the present invention is to provide a system and methods include a project management component configured to facilitate accountability and following up with project goals.

Yet another object of certain embodiments of the present invention is to provide a system and methods configured to facilitate study of a topic.

Yet another object of certain embodiments of the present invention is to provide a system and methods configured identify educational materials about a topic.

Yet another object of certain embodiments of the present invention is to provide a system and methods configured to identify the scope of a problem or an event.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A illustrates an embodiment of a system according to the present invention.

FIG. 1B illustrates an embodiment of a system according to the present invention.

FIG. 1C illustrates an embodiment of a system according to the present invention.

FIG. 2 illustrates an embodiment of a virtual event component according to the present invention.

FIG. 3 illustrates an embodiment of a user information component according to the present invention.

FIG. 4 illustrates an embodiment of a topic information component according to the present invention.

FIG. 5 illustrates an embodiment of a financial component according to the present invention.

FIG. 6 illustrates an embodiment of a project management component according to the present invention.

FIG. 7A illustrates an embodiment of a virtual event user interface according to the present invention.

FIG. 7B illustrates an embodiment of a virtual event user interface according to the present invention.

FIG. 7C illustrates an embodiment of a virtual event user interface according to the present invention.

FIG. 7D illustrates an embodiment of a virtual event user interface according to the present invention.

FIG. 8 illustrates an embodiment of a menu user interface according to the present invention.

FIG. 9 illustrates an embodiment of a topic page of a user interface according to the present invention.

FIG. 10A illustrates an embodiment of a region page of a user interface according to the present invention.

FIG. 10B illustrates an embodiment of a crisis map.

FIG. 10C illustrates an embodiment of a statistics component.

FIG. 11 illustrates an embodiment of a feature page user interface.

FIG. 12 illustrates an embodiment of a profile page user interface.

FIG. 13 illustrates an exemplary computer system.

FIG. 14 illustrates an exemplary cloud computing system.

FIG. 15A illustrates a method embodiment of the present invention.

FIG. 15B illustrates a method embodiment of the present invention.

### DETAILED DESCRIPTION OF EMBODIMENTS OF THE INVENTION

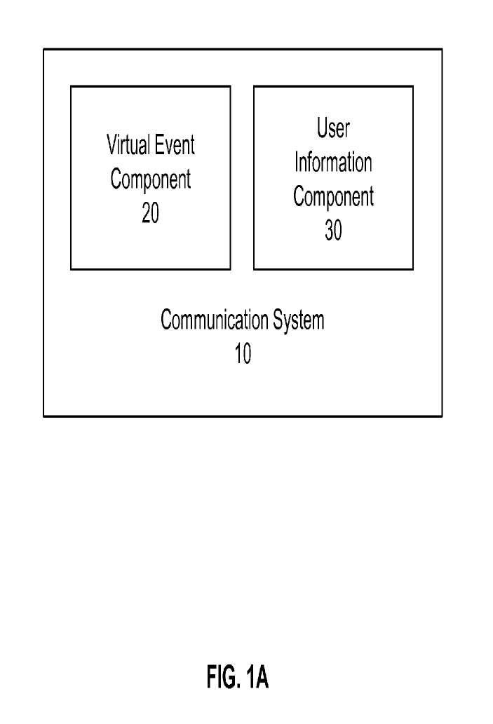

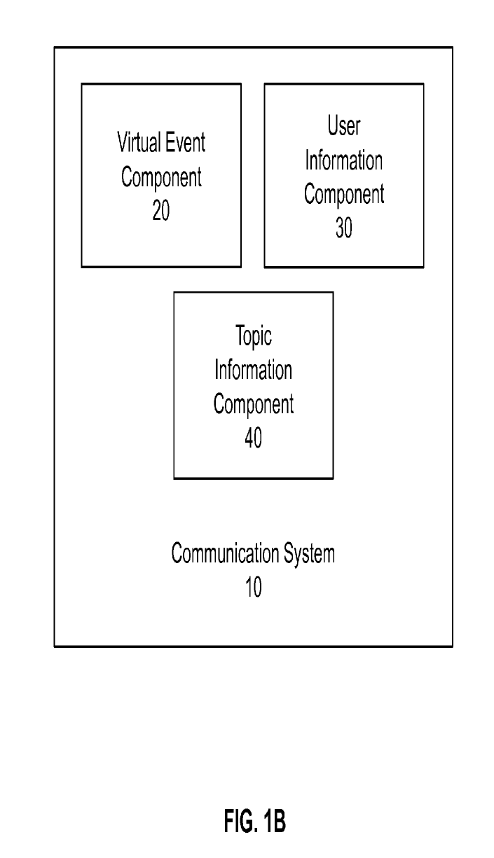

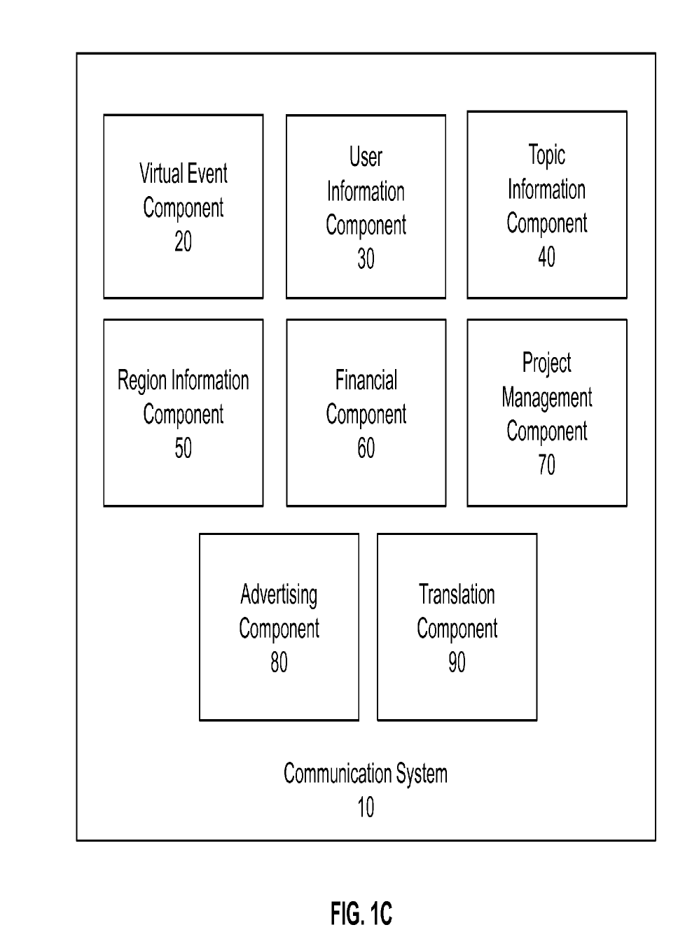

Certain of the simplest embodiments of the present invention include a virtual event component 20 and a user information component 30 as illustrated in FIG. 1A.

A virtual event component 20 is configured to permit communication between users of the system 10. For purposes of this application, a “virtual event” is an occasion on which one or more users access the system 10 at a specific time such that the users can interact generally in real-time through the system 10. Users may interact by sending and receiving video, audio, text, characters, codes, or other method known in the art. The users may pre-record an audio or video message to be played during the meeting or may transmit a video feed, audio feed, or text generally “live” during the meeting.

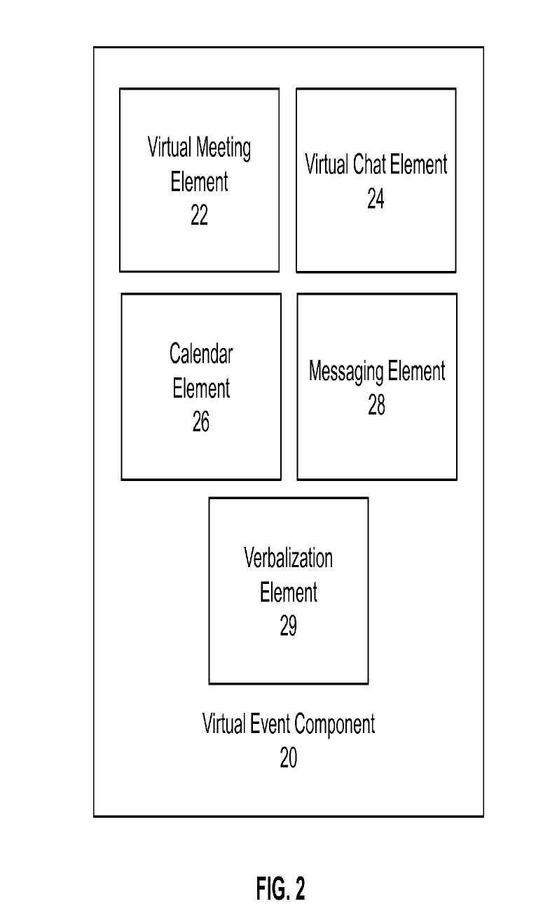

As illustrated in FIG. 2, a preferred embodiment of the virtual event component 20 includes at least a virtual meeting element 22. A virtual meeting element 22 is configured to permit various users to participate in a meeting using parliamentary procedure according to Robert's Rules of Order. Advantageously, parliamentary procedure is a procedure designed to permit a group of users to speak in an orderly manner and make decisions in an orderly manner.

A virtual event element 20 is configured to facilitate events other than virtual meetings as well. Such an embodiment may include a virtual chat element 24 configured to permit less formal discussions between users. A virtual chat element 24 may include an instant message component configured to permit exchange of text and other symbols between two or more users and a video or audio chat component configured to permit exchange of generally real-time exchange of video or audio between two or more users. A virtual chat element 24 permits generally free-form conversation and exchange of information.

A virtual event component 20 also may include a calendar element 26 configured to show the dates and times of events and also may include a call for users to join the event, RSVP to the event, or contribute to the event before it starts.

A virtual event component 20 also may include a messaging element 28, configured to permit exchange of information in messages that are stored in an inbox. While the users may view the inbox while messages are received, the inbox permits a user to send and receive messages while the user is not signed in or accessing the system at that time.

A virtual event component 20 also may include a verbalization element 29 configured to provide audio for certain words or sounds in a virtual event.

Certain embodiments of the system 10 also include a user information component 30 configured to permit a user to build a profile with a user input element 32. The user input element 32 may include fields to permit the user to enter the user's name, system username, password, address, email address, education, profession, experience (e.g., jobs, volunteer work, internships, externships, other), religion, ethnicity, heritage, reading list, movie list, publications, research blog, website, current location of user, and other relevant information.

Generally, the user information, and other information including topic information, region information, translation information, financial information, and project management information can be kept in an index, spreadsheet, catalog, or database. For purposes of this application, these analog and digital tools used by users to record and communicate information regarding topics will be termed generically “databases”.

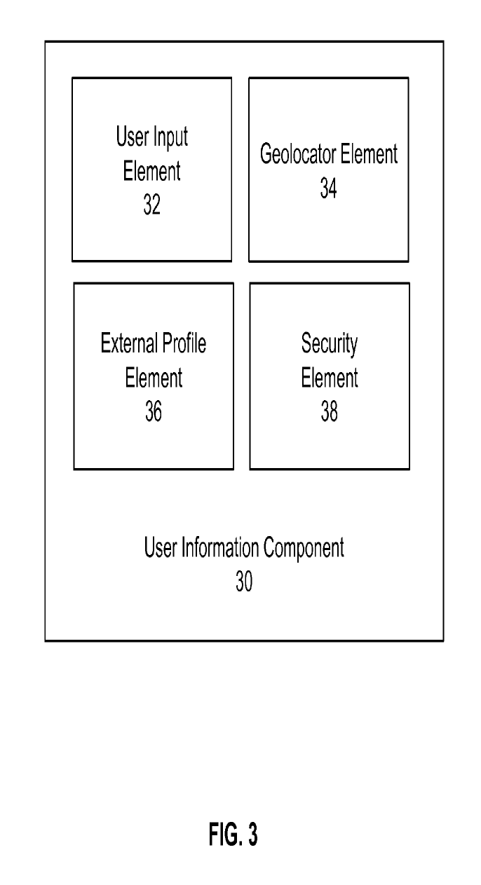

As illustrated in FIG. 3, a user information component 30 also may include a geolocator element 34 configured to identify and display the location of the user. Advantageously, a user does not need to manually update the location in such embodiments. A geolocator element 34 may be configured to use geolocation, triangulation, trilateration, or multilateration to determine the location of a user. Specifically, a geolocator element 34 may include a global positioning system (GPS), location detection based on WiFi, radio frequency (RF), IP-address and possibly related WHOIS data information, MAC address, RFID, Bluetooth, cell tower information, hardware embedded article/production number, embedded software number (such as UUID, Exif/IPTC/XMP or modern steganography), invoice, archival tags, dataloggers, a hybrid location detection unit or other automatic location detection system known in the art.

The geolocator element 34 may be configured to identify a country, region, city, postal/zip code, address, latitude, longitude, or timezone of a user.

A geolocator element 34 also may be configured to permit networking among members, for example, by causing a pop-up or push notification when a user is within a certain radius of another user.

Also illustrated in FIG. 3, a user information component 30 may include an external profile element 36 configured to import or link to information that a user has entered in a profile of an external system. For example, some or all of the user's information from Facebook, Twitter LinkedIn, WordPress, MySpace, an Email Account, or other social media system may be imported, linked, or displayed.

A user information component 30 also may include a security element 38 configured to provide the user with selective access to the user information component 30. Specifically, one user may use the security element to block other users from viewing certain sections or all of that user's user information or may permit only certain other users to view certain information added to the system 10.

Certain embodiments of the present invention also include a topic information component 40, as illustrated in FIG. 1B and FIG. 1C. While certain embodiments of the present invention are configured to facilitate communication regarding large-scale global topics, other embodiments may be configured to facilitate communication regarding small-scale or medium-scale topics.

Certain embodiments of the present invention may be configured to facilitate communication regarding topics related specifically to a single entity such as a country, city, organization, educational institution, or business.

Also, certain embodiments are configured to facilitate communication regarding a single topic, while other embodiments may be configured to facilitate communication regarding many topics.

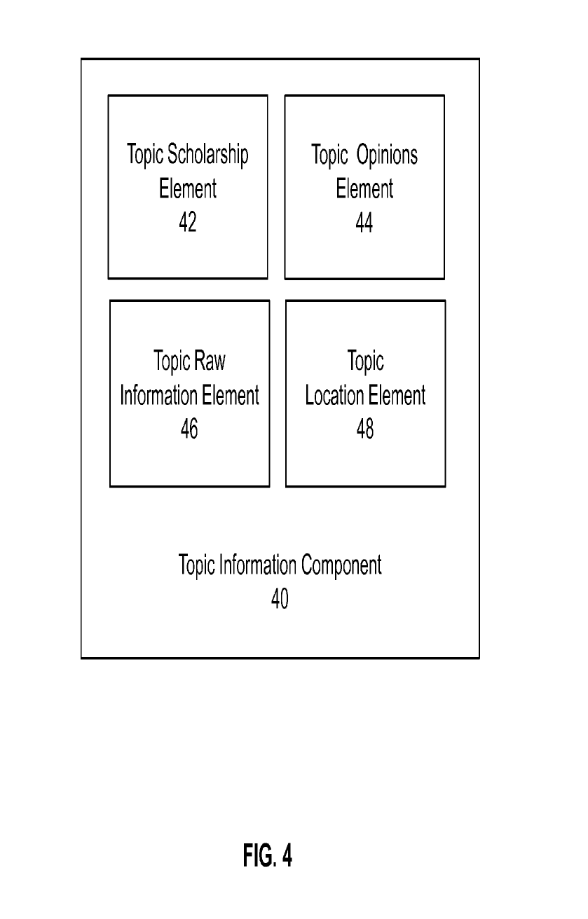

FIG. 4 illustrates an embodiment of a topic information component 40 configured to provide, organize, store, and display information about a topic. Certain embodiments of a topic information component 40 are configured specifically as a region information component 40A or any other topic.

A topic information component 40 is configured to store and display information related to a topic in a database and may include a topic scholarship element 42, topic opinions element 44, raw information element 46, and topic regions element 48 in a database.

A topic scholarship element 42 may include one or more “topic items” such as an article from a newspaper, encyclopedia, peer-reviewed publication, magazine, or other periodical, book, music, blog, unpublished material, image, art, documentaries, crisis map, geographic map, graph, photograph, timeline, drawing, institutional information, information from individual, social media entry (e.g., Twitter entry, Facebook entry, Pinterest entry, etc.), video recording, audio recording, and other information about the topic. Advantageously, certain embodiments are configured to incorporate information from a wide variety of sources such that a wide variety of viewpoints are represented. Alternatively, certain embodiments are configured for a certain audience and only include or prioritize the forms of information targeted to that audience. A topic scholarship element 42 also may include historical information.

The topic opinions element 44 may include information that constitutes an opinion, such as information that has not been supported by any research, information that goes against the weight of the evidence on the topic, or information that a user identifies as an opinion.

A topic raw information element 46 is configured to permit a user to upload, enter, store, transfer, or access a dataset such as raw data, big data, numbers, coded statistics, or other information. Such dataset may be large or small and may be obtained from research institutions, educational institutions, think tanks, governments, users, and other sources.

In addition, the raw information element 46 may be configured to process the dataset, specifically including tools configured for big data and small datasets. The raw information element 45 also may be configured to generate a report, display, or demonstration of the dataset, for example, in a graph, map such as a crisis map, geographic map, topographic map, or other type of map, video, image, timeline, or other. A display or demonstration of the dataset is termed a “system-generated output” for purposes of this application. A dataset may be stored in a database that is part of the system 10 or may be stored outside of the system 10 and accessed remotely by the system 10.

A topic raw information element 46 also may facilitate gathering data from users. For example, such embodiments may include a survey configured to gather information about a topic. If the user indicates the region they are in or the region they are from, certain information received in the responses may be illustrated in a map.

A topic location element 48 may be configured to convey location information about the topic. Certain embodiments may include information that identifies the regions to which the topic is relevant and may include, for example, a tags or labels on each topic item to associate it with a region. A topic location element 48 also may include a commentary on the topic as it relates to one or more regions including, for example, every continent or certain continent in the world, every country or certain countries in the world, certain cities in a country or across the world, etc. For example, a general “topic item” such as an article about the state of the global economy may include a commentary on the economy of each country in the world. The commentary may be a subsection of the article or may be a separate item linked to the article, for example, via hyperlink, bookmarklet, bookmark, shortcut, or other method known in the art. Each commentary may include a link to that country's general page and the country's general page may include a link to the commentary on that country's economy. For purposes of the application, the term “link” means hyperlink, bookmarklet, bookmark, shortcut, or other method known in the art to connect to another page, and may be displayed as a title, summary, or excerpt of the thing to which the link is connected.

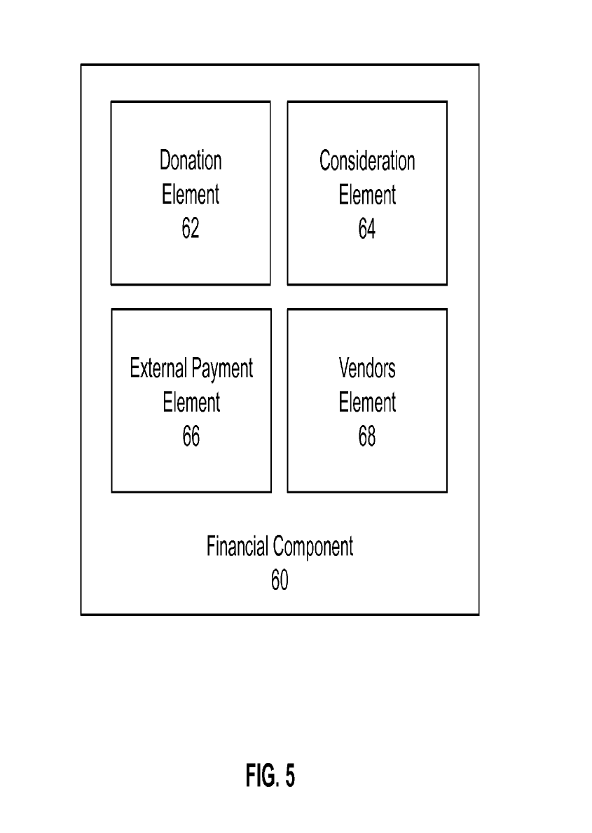

Certain embodiments of the present invention also include a financial component 60 configured to permit conducting financial transactions. A financial component 60 may include a donation element 62 and a consideration element 64 as illustrated in FIG. 5. The donation element 62 is configured to facilitate making and collecting donations to a recipient associated with a topic or region.

The consideration element 64 is configured to facilitate exchanging consideration among users of the system 10. Specifically, the consideration element 64 may assist in exchange of “Fair Trade” goods and services for money, specifically, permitting people in developing countries to improve trade, expand the market for goods and services, and promote sustainability. The consideration element 64 also may permit users to offer for sale and purchase region information articles, topic information articles available through the system 10, a system-generated output, or other goods and services.

A financial component 60 also may be configured to store the user's payment information such as name, mailing address, email address, credit card number, credit card expiration date, credit card security code, bank information. Additional embodiments of a financial component 60 may be configured to connect to an external payment element 66 configured to permit transfer of consideration, such as PayPal, amazonpayments, ING Direct Person2Person, Serve, Western Union, Google Wallet, etc.

Certain embodiments of a financial component 60 also may include a vendors component 68 configured to permit display and purchase of goods and services from vendors. For example, books, music, artwork, services, food, topic items, educational tools, and other items related to a topic may be featured and linked to a relevant vendor website or webpage or may be offered for sale. Other vendors may offer travel opportunities for voluntourism in which people volunteer for a charity or a cause while traveling.

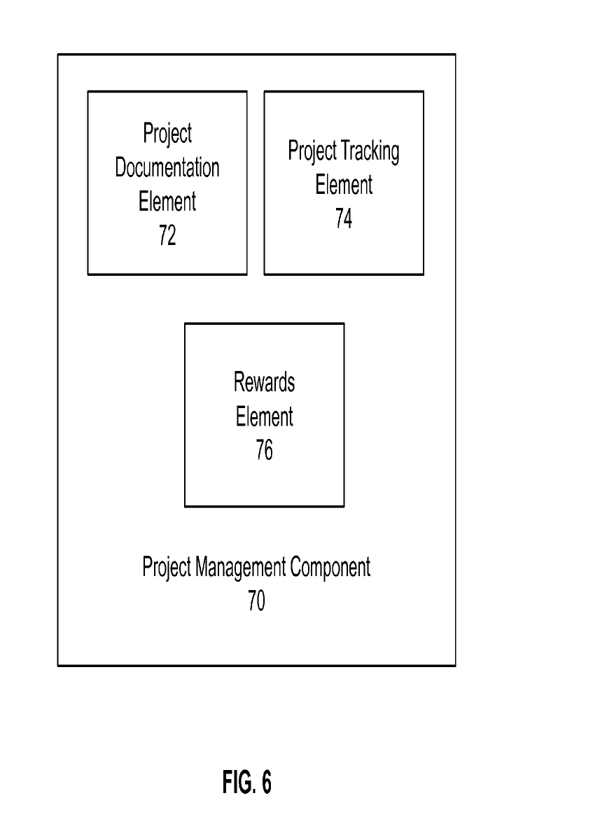

Certain embodiments of the present invention also include a project management component 70 having a project documentation element 72, a project tracking element 74, and a rewards element 76 as illustrated in FIG. 6. After a project has been identified by a user or a group of users, a project management strategy may be developed and progress of the project may be tracked. Specifically, the strategy may include reaching certain objectives, for example, raising money, raising awareness, writing and submitting an article for publication in the system, researching a topic, writing and submitting an article for publication in the system, developing solutions to problems, identify new topics or sub-categories of topics, etc. The project documentation element 72 is configured to receive, store, and display project information such as project objectives, project research, project progress, and project timeline.

The project tracking element 74 is configured to track the progress of the project by, for example, permitting the user to “check off” objectives that are completed, store documents related to objectives, display updates related to a timeline or reminders for completing objectives, display list of tasks completed by one or more users, and build and display progress chart for project.

Certain embodiments of a project management component 70 include a rewards element 76 configured to obtain and distribute rewards to the users who complete certain objectives. Rewards may include coupons, gift certificates, subscription to embodiments of the system, points redeemable for other value, or physical things. For example, certain users may benefit from the actions of other users or may wish to make a charitable contribution that will be distributed using the system 10.

Certain embodiments of the present invention include an advertising component 80 configured to permit advertisers to purchase and exhibit an advertisement for a good or service. Such component may permit the advertisers to target users who have certain qualities, are active in certain topic groups, have certain information in their profile information, live or visit certain regions, or have a geolocation. In certain embodiments, geolocation may permit advertisers may target their goods and services to users and customers in applicable areas and tailor their advertisements to each individual. This is a modernized version of the advertising and revenue model from local newspapers.

Certain embodiments of the present invention also include a translation component 90 configured to translate topic information such as text, audio recording, audio feed, video recording, or video feed into a language other than the native language or into the native language. Specifically, certain embodiments are configured to transfer sounds from an audio recording, audio feed, video recording, or video feed into a text display in which the words or sounds conveyed in the recording or feed are displayed in text, images, or characters.

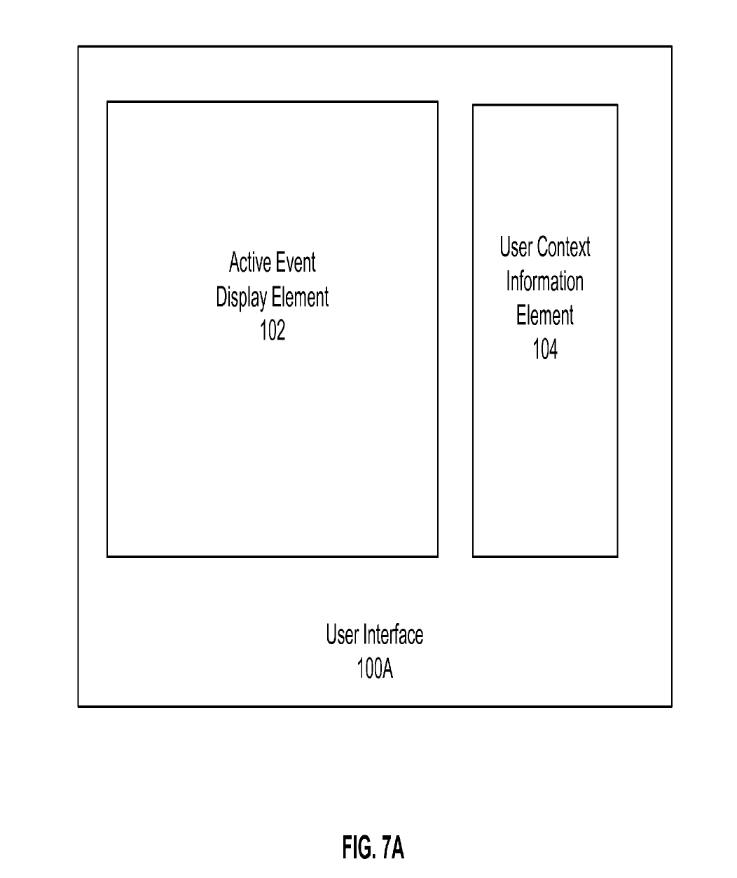

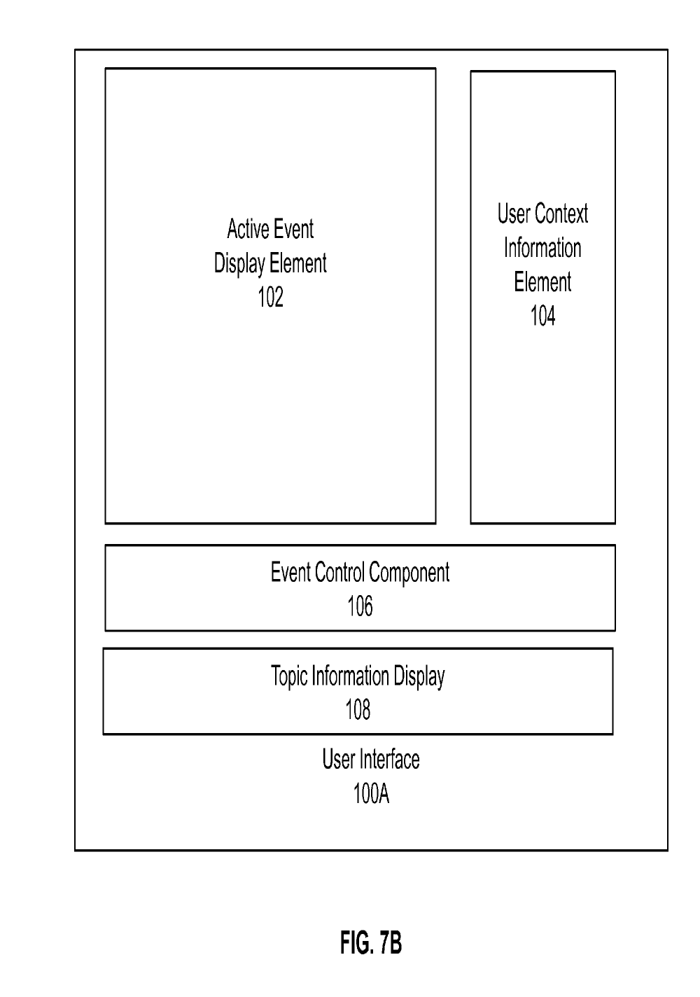

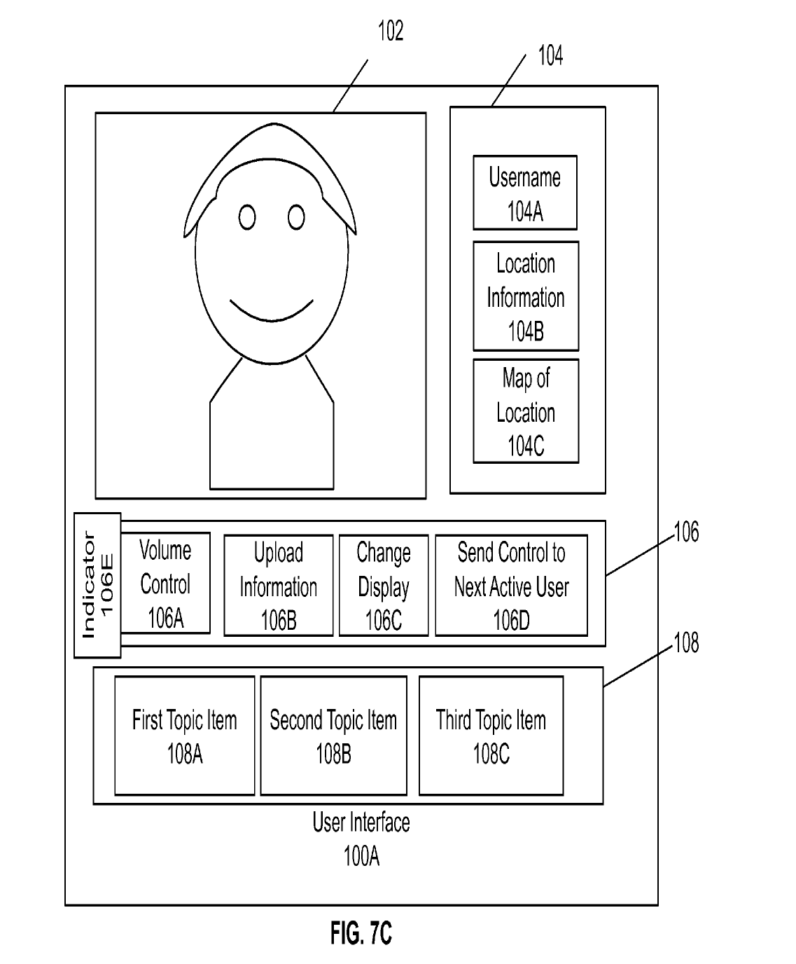

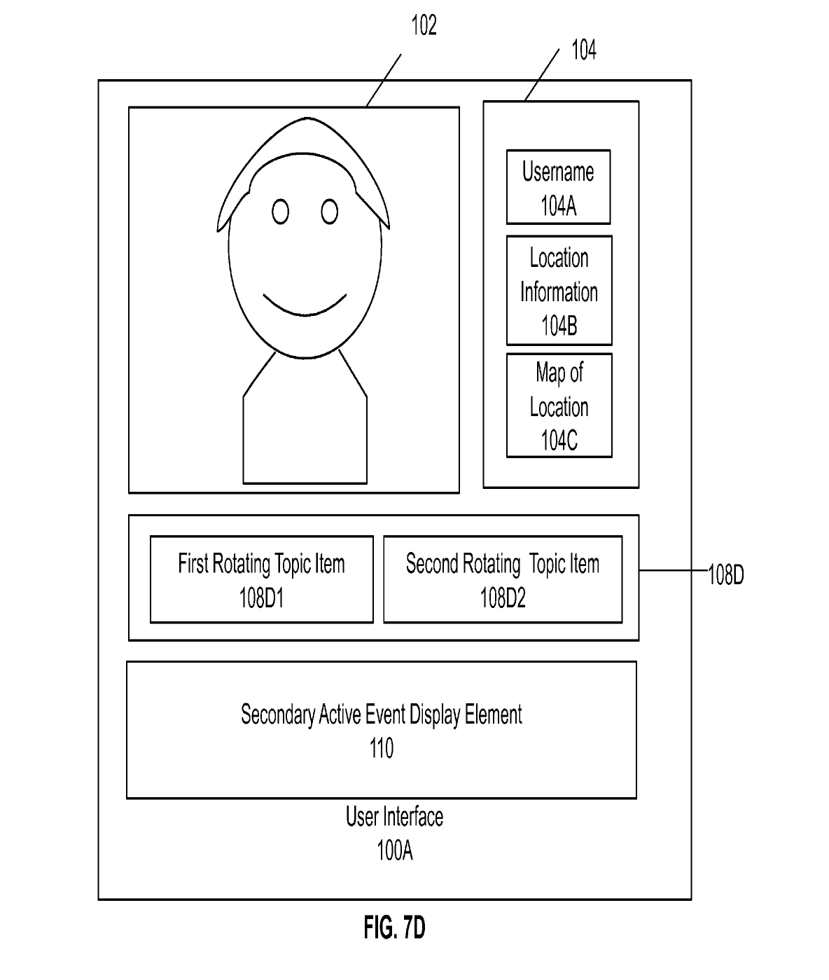

Certain embodiments of the present invention include a user interface 100 configured to be viewed via an input/output display. As illustrated in FIG. 7A, an embodiment of a virtual event user interface 100A may include an active event display element 102 configured to display a generally live video feed, video recording, image, or information during a virtual event. The active event display element 102 permits the display of the user whose turn it is to speak in the meeting via “user feed”. A “user feed” may include a video feed, recorded video, audio feed, recorded audio, image, text, files, topic items, or other information that the user wishes to have displayed.

When no user is speaking, an announcement may be posted regarding the status of the meeting or as a transition through the meeting, e.g., “not yet started”, “call to order”, “paused”, “introducing [next speaker name]”, “call for motions”, “intermission”, or “ended” to name a few. The active event display element 102 also permits display of an image or other information to which the user may wish to draw attention.

Certain embodiments of the virtual event user interface 100A include a user context information element 104 configured to display any type of user information about the user who is displayed in the active event display element 102. In certain embodiments, the user may select the specific information that will be displayed. In other embodiments, the information displayed will be selected based on context and relevance to the virtual event. The name, username 104A, location information 104B, map of location 104C, and background information often may be relevant to the event.

FIG. 7E illustrates another embodiment of the user context information 104 including a topic/user-based map 104D which displays some relationship between the user and the topic, a topic/user statistics component 104E which displays some relationship between the user and the topic in numeric form, a personal narrative component 104H in which the user provides information about his or her relationship with the topic, and personal proposals 104J in which the user provides information about action points or solutions related to a topic. User context information 104 also may include a user book list 104 in which the user identifies books that he or she has read or wishes to read related to the topic and may include links to purchasing the book, user reference list 104K in which the user identifies art, movies, museums references other than books that he or she has read, viewed, or identified as relevant to the topic, and an invitation to join a community 104L through which the user may invite users to join a community either online or in person. The user book list 104G and user reference list 104K may include a visual display of portions of the book or reference or may include a link to additional information about such book or reference.

In certain embodiments, system selectively activates one or more user feed in the active event display element 102. When a user feed is active, it is displayed. The system may display a user feed based on a first-come, first serve basis, such that the user's feeds are displayed in the order of submission. The system also may display the user feed in a pre-determined order or may prioritize users other selection criteria such as location relative to a reference point, contributions to previous virtual events, education level, or any other user information. In still other embodiments, the system may permit a user feed to be displayed based on a parliamentary procedure structure.

In certain embodiments, only one user feed is displayed at a time. In other embodiments, an active event display 102 may display multiple user feeds simultaneously. Specifically, a group of users may send their respective video feeds and all video feeds are displayed simultaneously. In such embodiments, the audio may be activated and inactivated depending on which user's turn it is to speak.

To permit the active user to control what is displayed to the users in the event, the virtual event user interface 100A may include an event control component 106 as illustrated in FIG. 7B and FIG. 7C. In certain embodiments, one user may have control throughout the event. In such embodiments, the user in control is acts as the “chairperson” of the meeting for purposes of parliamentary procedure.

In other embodiments, the control rotates between one or more users. Each user may be able to view all sections of the event control component 106, but not be able to activate any functions until control is transferred to that user.

For purposes of this application, the term “active user” identifies the user whose video feed or other information is displayed in the active event display element 102. Because it may be challenging to control the event control component 106 while speaking for a generally live video feed in certain embodiments, a producer user may control over the display while the active user is speaking. When control is transferred to the active user or producer user, an indicator is activated in the interface, for example, a control button or control button appears or an icon lights up or changes color. The event control component 106 will be discussed in more detail in other sections of this application.

In certain embodiments of the virtual event user interface 100A, the users may wish to access other information about the topic while viewing or listening to the active user. Accordingly, a topic information display component 108 is configured to permit a user to view topic items 108 as illustrated in FIG. 7B-FIG. 7D. As illustrated in FIG. 7D, rotating topic items 108D may rotate through the topic information display component 108. Rotating topic items 108D may include a feed of Twitter items, news articles, blog entries, or any other topic item.

The topic information display component 108 may be configured to selectively display information targeted to a user's location, a user's preferences, or a user's interests.

In certain embodiments, the system is configured to develop and go through an order of business automatically during a virtual meeting.

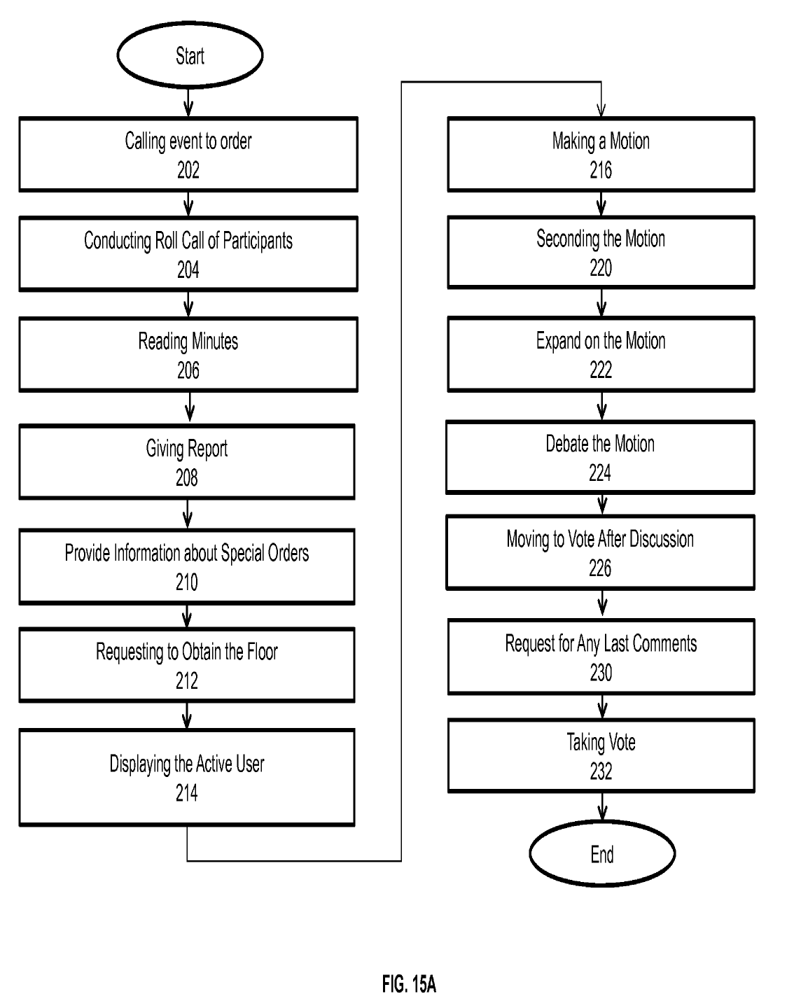

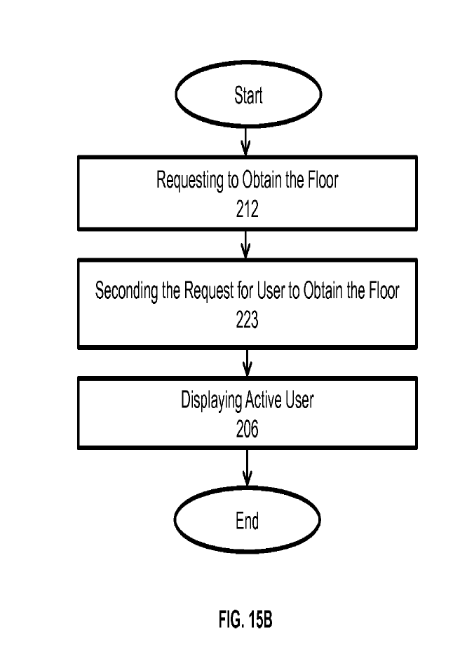

For example, the virtual meeting may begin by displaying a notification for a “call to order” 202 as illustrated in FIG. 15A.

Then, a roll call of participants—that is, the users who are authorized to participate in the meeting by submitting a video feed, video recording, audio feed, audio recording, text, or other for display—may be conducted 204. A roll call may include verbalization of each participant's name or username, either by an active user speaking into a microphone or by a verbalization component configured to verbalize names. The participants may respond by, for example, entering a response that is displayed in a secondary active event display element 110 as illustrated in FIG. 7D or by flashing the image or name of each participant in the active event display element 102.

In certain embodiments, a user or the verbalization component may read the minutes—that is, record of the event—from the previous event, if there was a previous event 206. Then, each participant who wishes or has been designated to give a report is displayed in the active event display element and gives a report possibly via video feed or audio feed 208.

Next, there is an opportunity for participants to provide information about special orders—that is, important business previously designated for consideration at the event 210. A participant may provide information by requesting to obtain the floor 212 making a short statement via video feed, by clicking an icon or otherwise conveying a request to obtain the floor and then waiting to be recognized by the chairperson user or the system (e.g., showing notification that the participant has the floor or displaying the active user 214). When the first participant has the floor, the participant will make a motion 216 by, for example, sending a note that states “I move that we . . . [fill in the blank]”. The note may be shown in the secondary active event display element. A second participant must “second” the motion before the motion moves to the next step 220. The motion may be “seconded” by clicking an icon designated “second motion” or otherwise entering a “second”. The chairperson user or the verbalization component state or a notification may be displayed in which the motion and second is acknowledged (e.g., “it has been moved and seconded that we . . . [fill in the blank]”.

The first participant may then expand on the motion by providing video feed, recorded video, audio feed, or text information for display 222. Participants other than a first participant may debate the motion 224 by providing video feed, recorded video, audio feed, or text information for display 226. Each participant may have a predetermined amount of time or characters to express their point.

Some participant may move to put the motion directly to a vote or may move to vote after discussion 228. If not, the chairperson user or the verbalization component will state or the notification display will show a request for any last comments 230.

Subsequently, a vote is taken 232. A vote may be taken by voice, by roll call, by general consent, by division, by ballot, by text submission, or by survey.

In certain embodiments, each and every rule in parliamentary procedure is incorporated into the virtual event. In other embodiments, only certain rules of parliamentary procedure are incorporated into the virtual event. For example, as illustrated in FIG. 15B, a virtual meeting may start by a user requesting to obtain the floor 212. Upon a second user seconding the request for the first user to obtain the floor 223, the first user's user feed will be displayed 206.

A virtual event also may be recorded for future viewing as they were displayed generally “live” or after editing or transcription, although some virtual events may not be recorded at all.

The virtual meetings advantageously may permit people in remote locations to have productive conversations about relevant topics.

Embodiments of the present invention may include additional method embodiments. For example, a user may create a survey and distribute a survey regarding a topic. Other users then respond to the survey, for example, by selecting choices or submitting free-form responses. The system then compiles the information from the responses and produces a system-generated output to illustrate the responses.

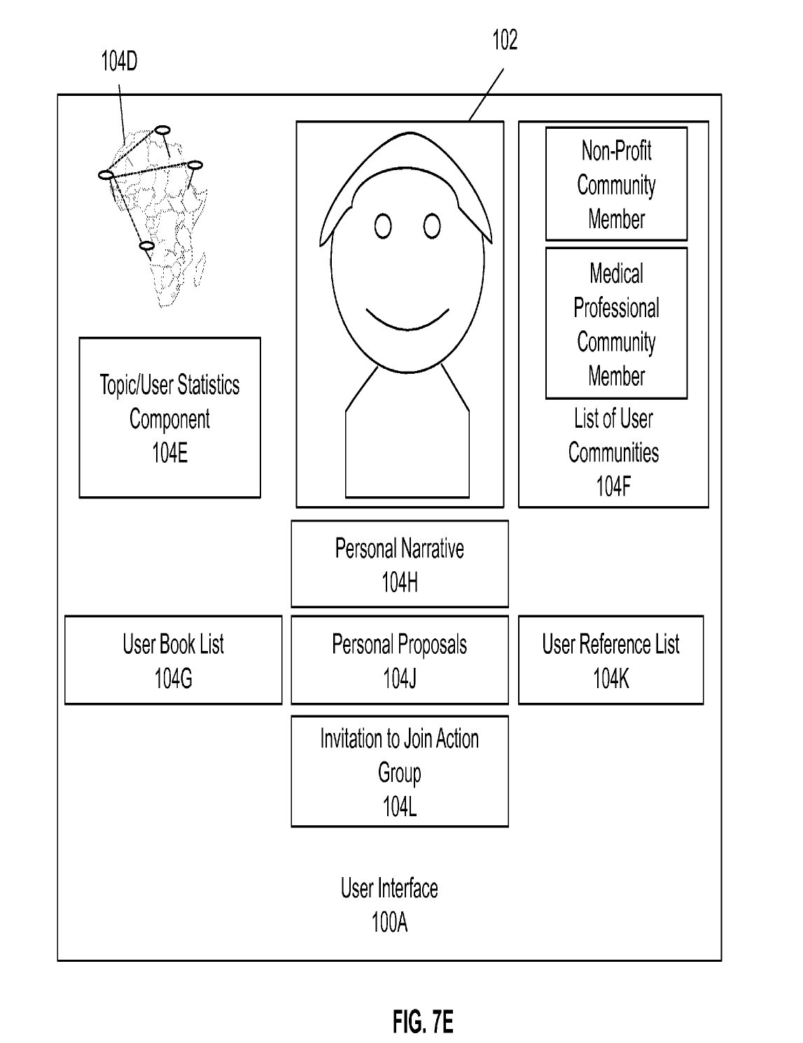

FIG. 8 illustrates another embodiment of the user interface 100, specifically, a menu user interface 100B configured to permit the user to navigate through the system 10. The illustrated embodiment include an expanded topic menu 120, link to the virtual event component 122, link to vendor component 124, and a link to the user information component 126. Certain embodiments of a menu user interface 100B also may include an advertising display element 128 configured to display an advertisement. Other user interface pages 100 may include advertising display elements 128 as well.

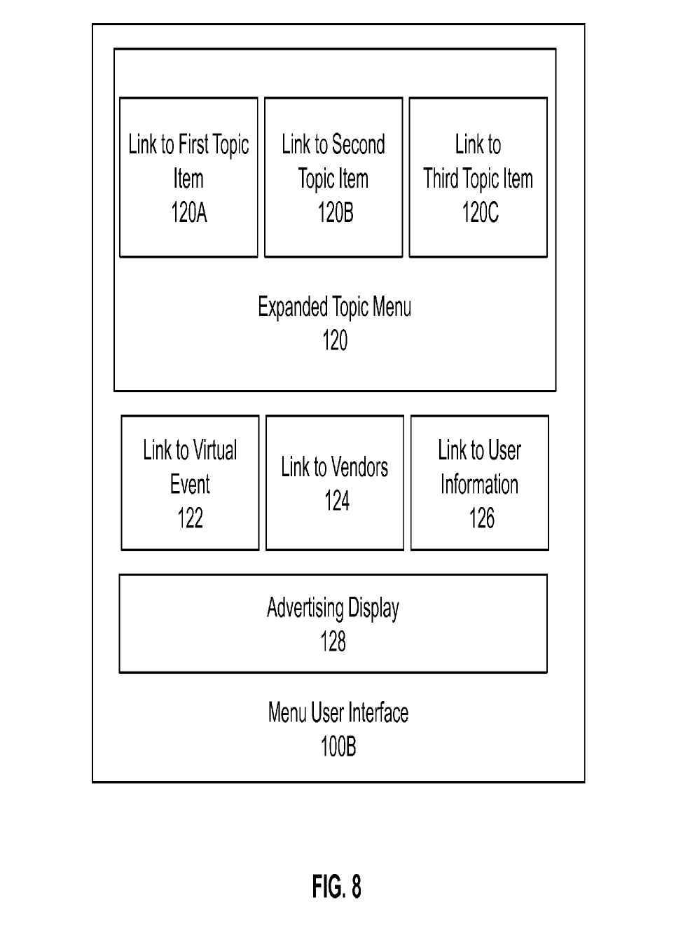

FIG. 9 illustrates an embodiment of a topic page user interface 100C configured to convey information about the topic. The illustrated embodiment of a topic page user interface 100C includes a topic summary 130, a first regional commentary regarding topic 132, a second regional commentary regarding topic 134, a third regional commentary regarding topic 136, and a topic image 138.

A topic summary 130 may include an overview of the topic from a global perspective, from a general perspective, from the perspective of someone specifically dealing with the topic.

A topic image 138 may include a photograph, drawing, painting, art, map, graph, chart or other image related to the topic.

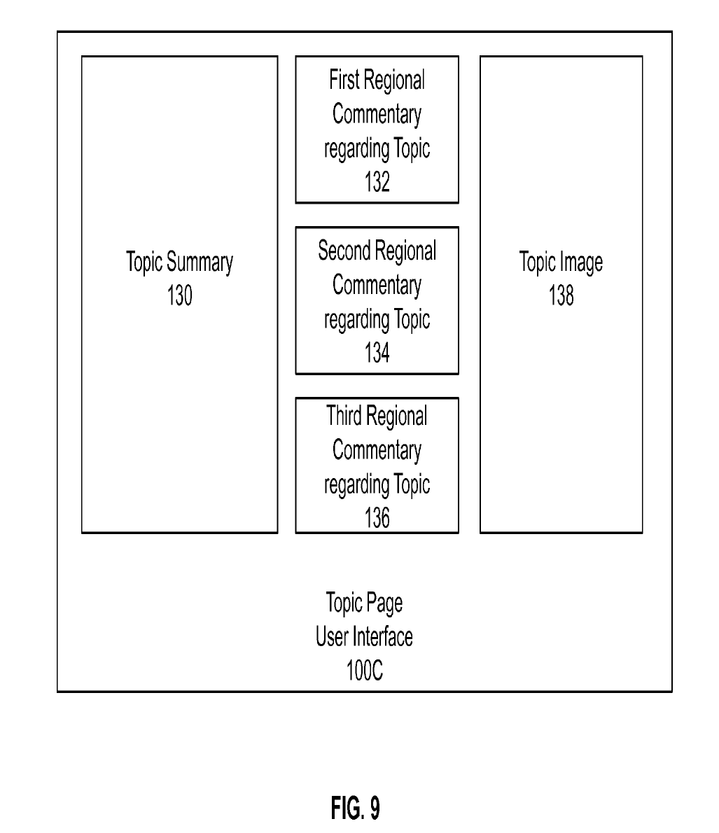

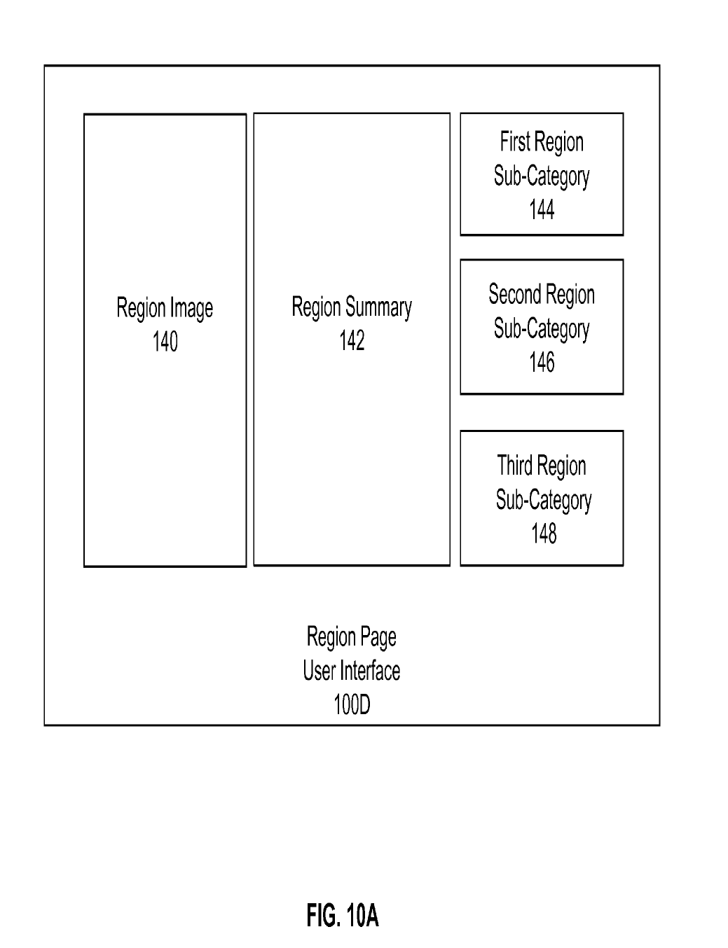

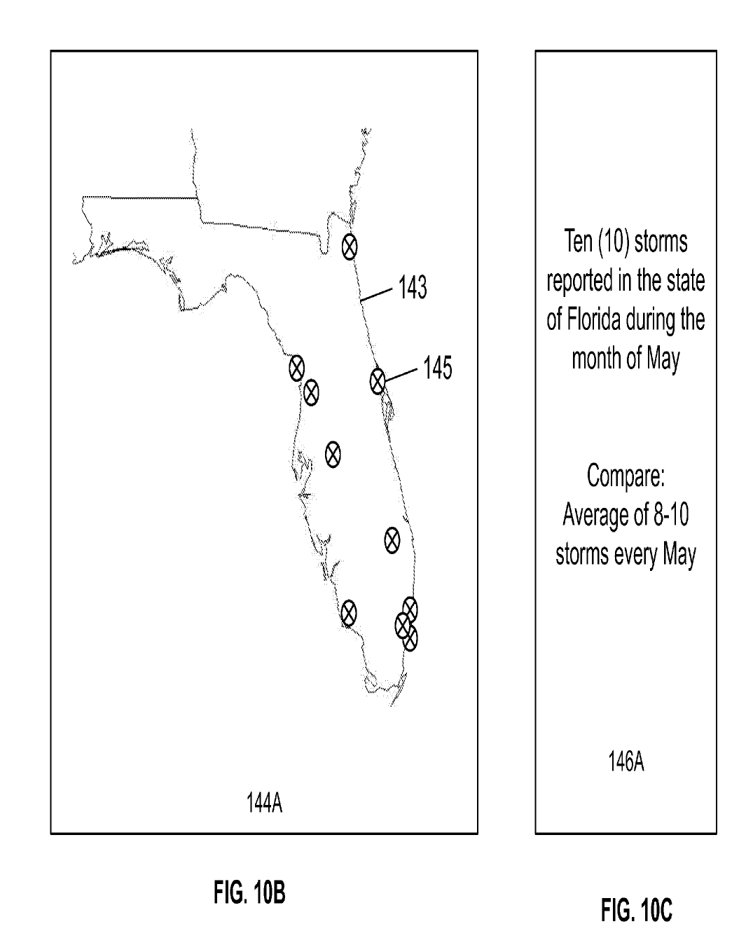

FIG. 10A illustrates an embodiment of a region page user interface 100D. The region page user interface 100D may include a region image 140, a region summary 142, a first region sub-category 144, second region sub-category 146 and a third region sub-category 146.

A region sub-category element 144, 146, 148 may include links to regional commentary regarding a topic 132, 134, 136, links to topic items 120A, 120B, 120C, display or links to Twitter entries or other social media entries from users in the region, map of a region including crisis map, geographic map, topographic map, climate map, economic resource map, political map, or road map, or a statistic component that displays numeric information about or associated with the region.

As illustrated in FIG. 10B, a region sub-category element configured as a crisis map 144A includes one or more symbols 145 (e.g., colors, characters, images, representations, icons, etc.) positioned on a map to indicate a status of an area. Crisis maps may be updated as close to real-time as possible or updated as new data becomes available. Each symbol represents an event or a status and is positioned at or near the location of the event or status relative to the location 143 (e.g., the state of Florida is illustrated in FIG. 10B).

A region sub-category element configured as a statistic component 146B may include population, area, gross domestic product, numbers related to economic state of the region, numbers related to the cultural state of the region, numbers related to the political state of the region, numbers related to the social state of the region, or other numbers measuring something about the region. An embodiment of a statistics component 146B is illustrated in FIG. 10C. Each region sub-category element may be the same type (e.g., multiple maps shown on one region page) or may be a different type (e.g., one map, one statistic component, one link to a regional commentary regarding a topic for each region page). Each region page may include a different combination of sub-category elements or may include the same combination of sub-category elements.

In certain embodiments, the present invention includes a region page user interface 100D configured to represent each and every country in the world. In other embodiments, a region page user interface 100D is configured to represent every state or province in a country. Other embodiments include other combinations of region page user interfaces 100D.

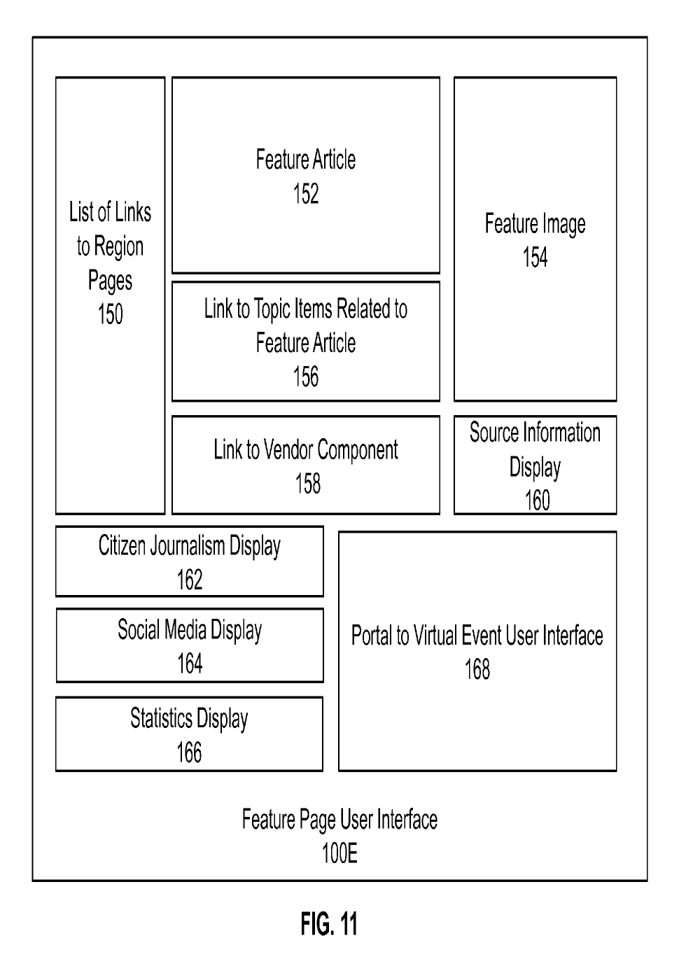

FIG. 11 illustrates an embodiment of a feature page user interface 100E including a feature article 152 and a featured image 154. The featured article 152 permits highlighting a topic because, for example, it has special relevance, influence, or need.

A feature page user interface 100E optionally may include one or more links to topic items related to content of a feature article 156, link to a vendor component 158 in which goods or services related to content of the feature article may be offered for sale or may include links to a vendor's shopping cart on an external website, and a source information display 160 configured to display a trademark or other source information about the feature article, components of the feature article, featured image, or component of feature image.

In addition, a feature page user interface 100E optionally may include a citizen journalism display 162, social media display 164, or statistics display 166. A citizen journalism display 162 is configured to show information produced by users that are not professional journalists. A social media display 164 is configured to display entries from external social media networks such as Twitter, LinkedIn, and Facebook. A statistics display 166 is configured to display statistics relevant to the feature article.

Additionally, a feature page user interface 100E optionally may include a portal to a virtual event user interface 186. Such portal may include a link to the virtual event user interface 100A, a view of the active event display element, an update regarding status of upcoming or past virtual events, or other information pertaining to virtual events.

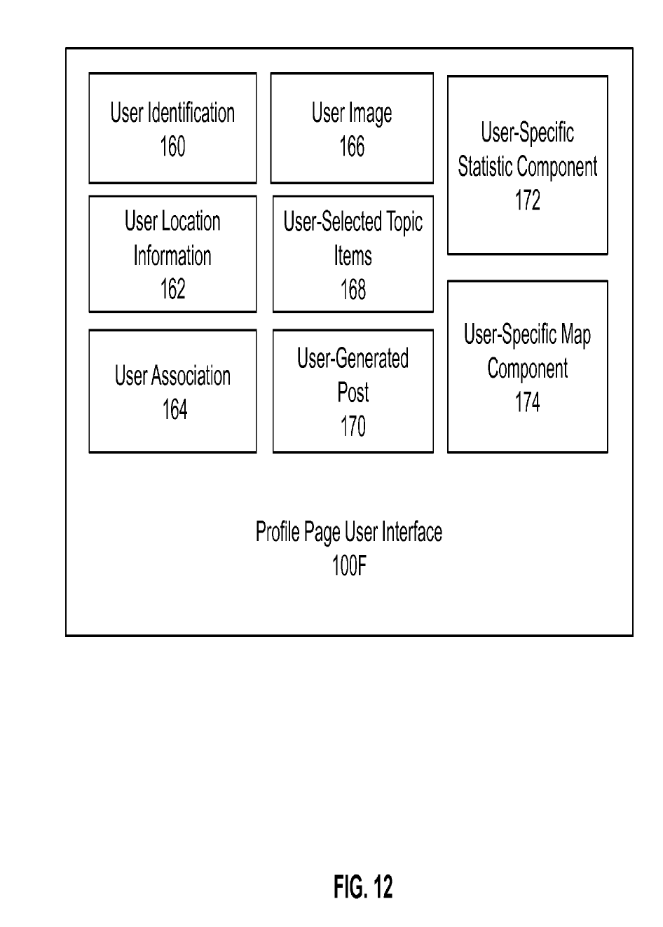

FIG. 12 illustrates an embodiment of a profile page user interface 100F configured to display user information and provide context for the user's experience relative to certain topics or regions.

A profile page user interface 100F may include user identification 160, user location information 162, user association information 164, and user image 166. The user location information 162 may be identified using a geolocator element 34 or other means of geolocation. The user association element 164 is configured to permit a user to join and display connections with other users, regions, communities, affiliations, and other elements of the system. The user may connect with topic items to showcase the user's interests, personality, location, or circumstances in the user-selected topics element 168. The user also may generate free-from posts for display in the user-generated post 170. Also, the user may generate or select or the system may assign various user-specific statistic components 172 and user-specific map components 174.

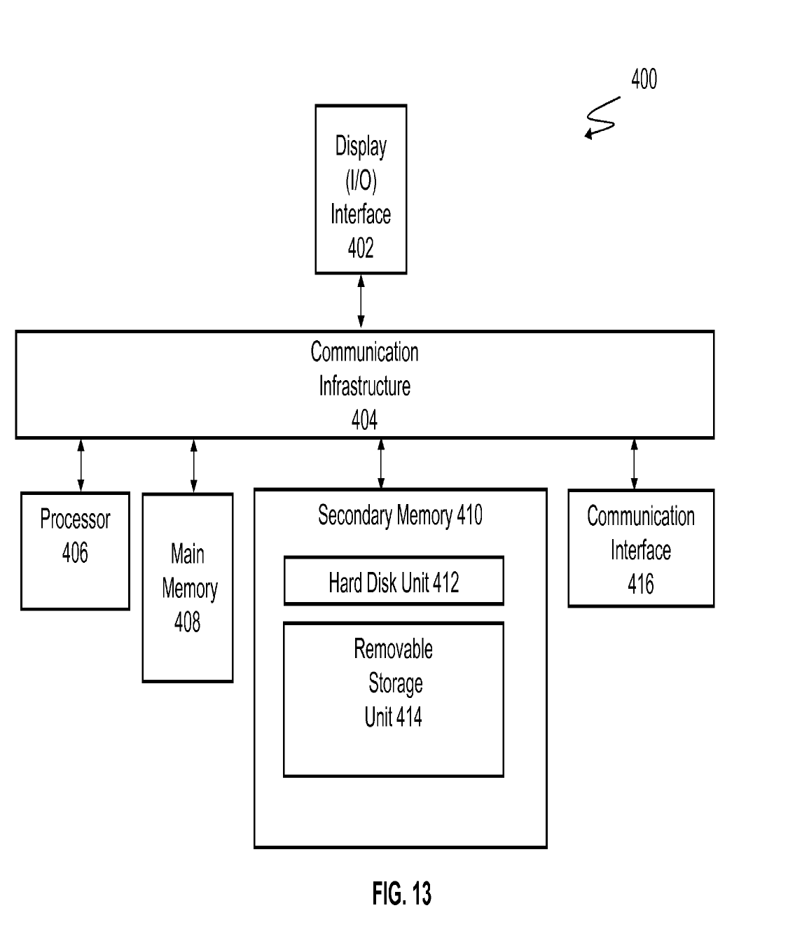

FIG. 13 illustrates an exemplary computer system 400 that may be used to implement the methods according to the invention. One or more computer systems 400 may carry out the methods presented herein as computer code.

Computer system 400 includes an input/output display interface 402 connected to communication infrastructure 404—such as a bus—, which forwards data such as graphics, text, and information, from the communication infrastructure 404 or from a frame buffer (not shown) to other components of the computer system 400. The input/output display interface 402 may be, for example, a keyboard, touch screen, joystick, trackball, mouse, monitor, speaker, printer, microphone, projector, 3-D screen, 3-D glasses, webcam, camera, any other computer peripheral device, or any combination thereof, capable of entering and/or viewing data.

Computer system 400 includes one or more processors 406, which may be a special purpose or a general-purpose digital signal processor that processes certain information. Computer system 400 also includes a main memory 408, for example random access memory (“RAM”), read-only memory (“ROM”), mass storage device, or any combination thereof. Computer system 400 may also include a secondary memory 410 such as a hard disk unit 412, a removable storage unit 414, or any combination thereof. Computer system 400 may also include a communication interface 416, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 408, secondary memory 410, communication interface 416, or a combination thereof, function as a computer usable storage medium, otherwise referred to as a computer readable storage medium, to store and/or access computer software including computer instructions. For example, computer programs or other instructions may be loaded into the computer system 400 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 414 or hard disc unit 412 to the secondary memory 410 or through the communication infrastructure 404 to the main memory 408 of the computer system 400.

Communication interface 416 allows software, instructions and data to be transferred between the computer system 400 and external devices or external networks. Software, instructions, and/or data transferred by the communication interface 416 are typically in the form of signals that may be electronic, electromagnetic, optical or other signals capable of being sent and received by the communication interface 416. Signals may be sent and received using wire or cable, fiber optics, a phone line, a cellular phone channel, a Radio Frequency (“RF”) channel, wireless elements, or other communication channels.

Computer programs, when executed, enable the computer system 400, particularly the processor 406, to implement the methods of the invention according to computer software including instructions.

The computer system 400 described herein may perform any one of, or any combination of, the steps of any of the methods presented herein. It is also contemplated that the methods according to the invention may be performed automatically, or may be invoked by some form of manual intervention.

The computer system 400 of FIG. 13 is provided only for purposes of illustration, such that the invention is not limited to this specific embodiment. It is appreciated that a person skilled in the relevant art knows how to program and implement the invention using any computer system.

The computer system 400 may be a handheld device and include any small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPad Touch® or iPhone® or Apple TV or other larger systems.

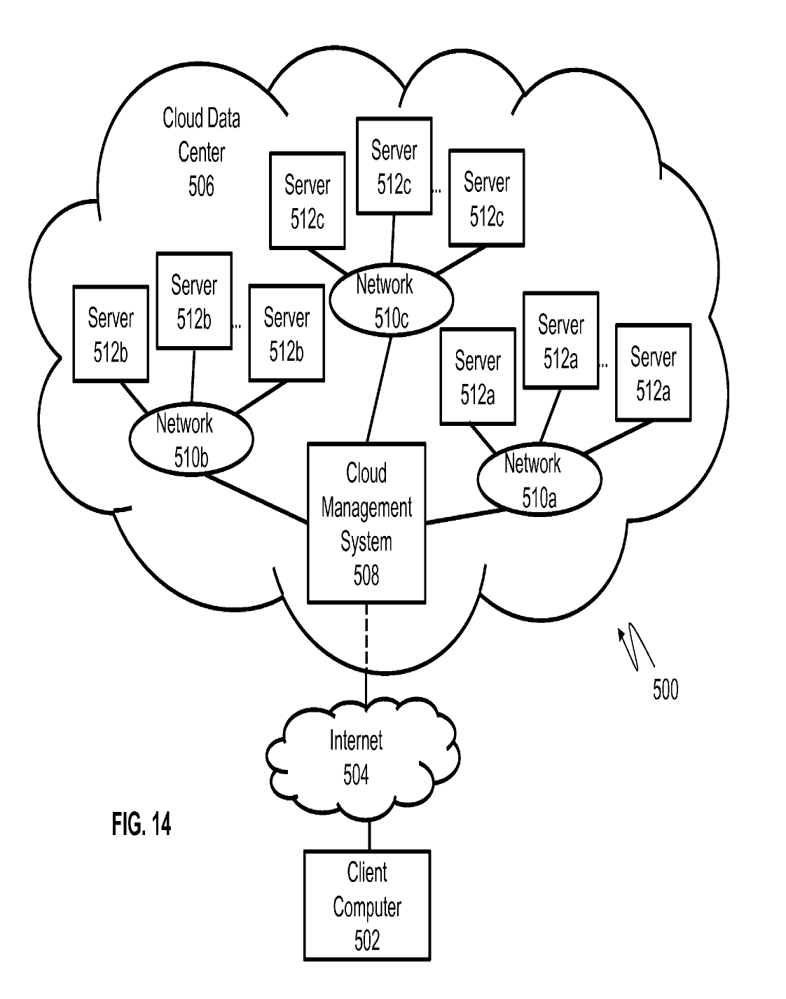

FIG. 14 illustrates an exemplary cloud computing system 500 that may be used to implement the methods according to the present invention. The cloud computing system 500 includes a plurality of interconnected computing environments. The cloud computing system 500 utilizes the resources from various networks as a collective virtual computer, where the services and applications can run independently from a particular computer or server configuration making hardware less important.

Specifically, the cloud computing system 500 includes at least one client computer 502. The client computer 502 may be any device through the use of which a distributed computing environment may be accessed to perform the methods disclosed herein, for example, a traditional computer, portable computer, mobile phone, personal digital assistant, tablet to name a few. The client computer 502 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 502 also includes a communications interface, for example, a modem, a network interface (such as an Ethernet card), a communications port, a PCMCIA slot and card, wired or wireless systems, etc. The communications interface allows communication through transferred signals between the client computer 502 and external devices including networks such as the Internet 504 and cloud data center 506. Communication may be implemented using wireless or wired capability such as cable, fiber optics, a phone line, a cellular phone line, radio waves or other communication channels.

The client computer 502 establishes communication with the Internet 504—specifically to one or more servers—to, in turn, establish communication with one or more cloud data centers 506. A cloud data center 506 includes one or more networks 510a, 510b, 510c managed through a cloud management system 508. Each network 510a, 510b, 510c includes resource servers 512a, 512b, 512c, respectively. Servers 512a, 512b, 512c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 508 can comprise a dedicated or centralized server and/or other software, hardware, and network tools to communicate with one or more networks 510a, 510b, 510c, such as the Internet or other public or private network, with all sets of resource servers 512a, 512b, 512c. The cloud management system 508 may be configured to query and identify the computing resources and components managed by the set of resource servers 512a, 512b, 512c needed and available for use in the cloud data center 506. Specifically, the cloud management system 508 may be configured to identify the hardware resources and components such as type and amount of processing power, type and amount of memory, type and amount of storage, type and amount of network bandwidth and the like, of the set of resource servers 512a, 512b, 512c needed and available for use in the cloud data center 506. Likewise, the cloud management system 508 can be configured to identify the software resources and components, such as type of Operating System (“OS”), application programs, and the like, of the set of resource servers 512a, 512b, 512c needed and available for use in the cloud data center 506.

The present invention is also directed to computer products, otherwise referred to as computer program products, to provide software to the cloud computing system 500. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 500 of FIG. 14 is provided only for purposes of illustration and does not limit the invention to this specific embodiment. It is appreciated that a person skilled in the relevant art knows how to program and implement the invention using any computer system or network architecture.

While the disclosure is susceptible to various modifications and alternative forms, specific exemplary embodiments of the present invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method for communicating information between two or more users, comprising the steps of:
providing a virtual event user interface configured to be viewed in a display;
requesting to obtain the floor in the virtual event user interface by a first user;
seconding the first user request to obtain the floor by a second user; and
displaying a user feed of a first user in the virtual event user interface.

2. The method of claim 1, further comprising the step of presenting user context information in the virtual event user interface adjacent to the user feed.

3. The method of claim 1, further comprising the steps of:
importing a dataset of information related to a topic; and
storing the dataset of information related to the topic in a database.

4. The method of claim 3, further comprising the steps of:
converting the information into a system-generated output.

5. The method of claim 4, wherein the system-generated output is a crisis map.

6. The method of claim 4, wherein the system-generated output is a statistic component.

7. The method of claim 1, further comprising the steps of:
creating a survey regarding a topic;
distributing the survey regarding a topic;
receiving responses to the survey regarding a topic;
calculating results of the survey from the responses;
exhibiting the results of the survey in a system-generated output.

8. The method of claim 1, further comprising the steps of:
calling to order a virtual event;
reading minutes from an earlier virtual event; and
giving a report about a topic.

9. The method of claim 1, further comprising the steps of:
making a motion by a first user;
seconding the motion by a second user;
expanding on the motion by a first user;
debating the motion by a second user or a third user;
moving to send the motion to a vote;
requesting any last comments; and
taking the vote.

10. The method of claim 1, further comprising the steps of:
preparing an action plan related to a topic;
tracking progress of action plan; and
documenting action plan.

11. A communication system configured to facilitate controlled exchange of information, comprising:
a processor;
a main memory in communication with the processor via a communication infrastructure and storing instructions that, when executed by the processor, cause the processor to:
provide a virtual event user interface configured to be viewed in a display;
request to obtain the floor in the virtual event user interface by a first user;
second the first user request to obtain the floor by a second user; and
display a user feed of a first user in the virtual event user interface.

12. The system of claim 10, further comprising instructions that cause the processor to present user context information in the virtual event user interface adjacent to the user feed.

13. The system of claim 10, further comprising instructions that cause the processor to import a dataset of information related to a topic and store the dataset of information related to the topic in a database.

14. The system of claim 11, further comprising instructions that cause the processor to convert the information into a system-generated output.

15. The system of claim 12, wherein the system-generated output is a crisis map.

16. The system of claim 12, wherein the system-generated output is a statistic component.

17. The system of claim 10, further comprising instructions that cause the processor to:
create a survey regarding a topic;
distribute the survey regarding a topic;
receive responses to the survey regarding a topic;
calculate results of the survey from the responses;
exhibit the results of the survey in a system-generated output.

18. The system of claim 10, further comprising instructions that cause the processor to:
call to order a virtual event;
read minutes from an earlier virtual event; and
give a report about a topic.

19. The system of claim 10, further comprising instructions that cause the processor to:
make a motion by a first user;
second the motion by a second user;
expand on the motion by a first user;
debate the motion by a second user or a third user;
move to send the motion to a vote;
request any last comments; and
take the vote.

20. A method for communicating information between two or more users, comprising the steps of:
showing a profile page user interface in a display;
using geolocation to generate location information included in the profile page user interface;
collecting big data statistics, portions of which are displayed the profile page user interface; and
exhibiting a narrative designed to convey how a user is impacted by a topic, thereby illustrating the user's connection to the topic.
